(19) United States
(12) Patent Application Publication
(10) Pub. No.: US 2026/0328384 A1
(43) Pub. Date: Oct. 22, 2026

(54) INSTALLATION AND METHOD FOR PROVIDING PROCESS STEAM, USING A HEAT SOURCE

(71) Applicants: GENVIA, Béziers Cedex (FR); SCHLUMBERGER TECHNOLOGY CORPORATION, Sugar Land, TX (US)

(72) Inventor: Romuald COUPAN, Magny-le-Hongre (FR)

(21) Appl. No.: 19/486,268

(22) PCT Filed: May 16, 2024
(86) PCT No.: PCT/EP2024/063547

§ 371 Date: Nov. 20, 2025

(30) Foreign Application Priority Data
May 23, 2023 (FR) FR2305086

(51) Int. Cl. F22B 1/02; F22G 1/00; F28D 20/00

(52) U.S. Cl. CPC F22B 1/021; F28D 20/00; F22G 1/00

(57) ABSTRACT

An installation and method for supplying process steam by waste heat recovery is disclosed. The installation includes heat transfer devices and an energy storage device, a first circuit configured to receive a first fluid; a second circuit configured to receive a second heat transfer fluid; a third circuit configured to receive a third fluid: a first heat transfer device configured to transfer heat from the third fluid to the second fluid to increase the temperature of the second fluid; a second heat transfer device configured to transfer heat from the second fluid to a flow of the first fluid in gaseous state to increase the temperature of the gaseous flow; and a thermal storage device configured to store heat from the second fluid and is designed to change configuration according to the temperature and/or flow conditions of the source.

### TECHNICAL FIELD

The invention relates to the field of industrial steam generation, that is, steam used in industrial processes.

The invention is of particular interest, but by no means limiting, for supplying steam to a process for producing hydrogen by steam electrolysis, also known as “high-temperature electrolysis”, where steam typically requires a temperature of between 600 °C and 850 °C.

### PRIOR ART

Industrial steam is generally produced by generators using electricity or fossil fuels as the energy source.

There is a need to reduce the ecological impact of industrial steam generators.

### DISCLOSURE OF THE INVENTION

To this end, one object of the invention is an installation for providing steam, comprising:
a first circuit configured to receive a first fluid,
a second circuit configured to receive a second heat transfer fluid,
a third circuit configured to receive a third fluid,
a first heat transfer device configured to transfer heat from said third fluid to said second fluid in order to increase the temperature of the second fluid,
a second heat transfer device configured to transfer heat from said second fluid to a flow of said first fluid in gaseous state in order to increase the temperature of this gaseous flow,
a thermal storage device configured to store heat from said second fluid.

The installation is configured so that it can be selectively placed in one of several configurations from a list including:
a so-called “direct exchange configuration”, wherein the second circuit is configured to convey the second fluid from the first heat transfer device to the second heat transfer device,
a so-called “thermal discharge configuration”, wherein the second circuit is configured to convey the second fluid from the thermal storage device to the second thermal transfer device.

The first fluid, also known as the “output fluid”, preferably comprises water, so that the installation can provide steam in the form of water vapor.

Non-limitingly, the second fluid comprises oil or water.

Non-limitingly, the third fluid contains waste heat which can come from many types of industries or processes, for example from a cement plant, a steel plant, a plant in the chemical sector or from various processes generating exothermic reactions.

The third fluid may be gaseous and/or liquid. Non-limitingly, the third fluid, also known as the “input fluid”, may comprise a combustion gas, air or water vapor.

The direct exchange configuration advantageously allows the gas stream passing through the second heat transfer device to be heated using heat recovered from the third fluid.

The thermal discharge configuration advantageously allows the gas flow passing through the second heat transfer device to be heated using heat stored in the thermal storage device.

The invention makes it possible to generate steam using a source of waste heat and, depending, for example, on the temperature or flow conditions of the third fluid and/or on requirements, to switch from one configuration to another.

In one embodiment, the list includes a so-called “thermal loading configuration”, wherein the second circuit is configured to convey the second fluid from the first heat transfer device to the thermal storage device.

The thermal loading configuration advantageously allows heat recovered from the third fluid to be stored in the thermal storage device.

In one embodiment, said list includes a configuration, called the “mixed configuration”, wherein the second circuit is configured to convey the second fluid from the first heat transfer device to the thermal storage device and from the thermal storage device to the second heat transfer device.

The mixed configuration advantageously makes it possible both to heat the gas flow passing through the second heat transfer device using heat recovered from said third fluid and to store heat recovered from said third fluid in the thermal storage device.

In one embodiment, the installation comprises a heating device configured to raise the temperature of the second fluid upstream of the second heat transfer device.

Advantageously, such a heating device allows the gas flow passing through the second heat transfer device to be heated using an external energy source, for example when the energy available in the thermal storage device or in the third fluid is insufficient, and/or to facilitate start-up of the installation.

Preferably, the heating device is electric.

In one embodiment, the second circuit comprises a heating device bypass branch.

The second circuit is preferably configured to convey the second fluid from the first heat transfer device to the second heat transfer device via the bypass branch when the installation is in said direct exchange configuration.

The second circuit is preferably configured to convey the second fluid from the second thermal storage device to the second heat transfer device via the bypass branch when the installation is in said thermal discharge configuration and/or in that mixed configuration.

In one embodiment, said list includes a so-called “electrical configuration”, wherein the second circuit is configured to convey the second fluid from the thermal storage device to the heating device and from the heating device to the second heat transfer device.

The electrical configuration advantageously allows the gas flow passing through the second heat transfer device to be heated using an external energy source, for example when the energy available in the thermal storage device is insufficient.

In one embodiment, said list includes a configuration wherein the second circuit is configured to convey the second fluid from the first heat transfer device to the heating device and from the heating device to the second heat transfer device.

Advantageously, such a configuration makes it easier to start up the installation, for example before placing the installation in said direct exchange configuration.

In one embodiment, said list includes a configuration wherein the second circuit is configured to convey the second fluid from the first heat transfer device to the thermal storage device, from the thermal storage device to the heating device and from the heating device to the second heat transfer device.

Advantageously, such a configuration makes it easier to start up the installation, for example before placing the installation in said mixed configuration.

In one embodiment, the installation comprises a sensor configured to estimate the temperature of said third fluid and control means configured to place the installation in said direct exchange configuration if the estimated temperature of the third fluid is above a first predetermined temperature threshold and below a second predetermined temperature threshold, the second threshold being lower than the first threshold.

In one embodiment, the control means are configured to place the installation in said mixed configuration if the estimated temperature of the third fluid is greater than or equal to said second threshold.

In one embodiment, the first temperature threshold corresponds to the addition of a measured or desired temperature of the gas flow leaving the second heat transfer device and a first constant temperature value, said first constant temperature value being equal to 5 °C, for example.

In one embodiment, the second temperature threshold corresponds to the addition of a measured or desired temperature of the gas flow leaving the second heat transfer device and a second constant temperature value, said second constant temperature value being equal to 20 °C, for example.

Of course, the installation can also comprise other components.

For example, and non-limitingly, the installation may comprise a steam generation module comprising said second heat transfer device.

In one embodiment, the steam generation module may comprise an evaporator configured to convert the first fluid from a liquid state to a gaseous state.

The invention also relates to a method for providing steam implementing an installation as defined hereinbefore, comprising:
a heat transfer step, wherein said first heat transfer device is operated to transfer heat from the third fluid to the second fluid in order to increase the temperature of the second fluid,
a control step, wherein the installation is selectively placed in one of several configurations from a list including:
   a so-called “direct exchange configuration”, wherein said second circuit is configured to convey the second fluid from the first heat transfer device to the second heat transfer device so as to perform a superheating step, wherein the second heat transfer device is operated to transfer heat from the second fluid to a flow of the first fluid in gaseous state in order to increase the temperature of this gaseous flow,
   a so-called “thermal discharge configuration”, wherein the second circuit is configured to convey the second fluid from the thermal storage device to the second heat transfer device, wherein the second heat transfer device is operated to transfer heat from the second fluid to a flow of the first fluid in gaseous state in order to increase the temperature of this gaseous flow.

The method can of course comprise steps corresponding to the implementation of one or more of the configurations described above and/or other steps for implementing the installation.

For example, and non-limitingly, the method may comprise an evaporation step, in which said evaporator is operated to convert the first fluid from a liquid state to a gaseous state.

Generally speaking, the invention makes it possible to produce industrial steam using a source of waste heat, while ensuring a continuous supply of steam despite fluctuations in the flow rate or temperature of the source.

Compared with electrical steam generation technologies, the invention allows a substantial reduction in electrical energy consumption.

The invention further makes it possible to produce process steam without using a combustion generator, thereby substantially reducing pollutant emissions, including carbon dioxide.

The invention can be used in a wide range of industrial applications, for example using steam in electrolytic hydrogen production methods or in steam turbine power plants.

Further advantages and features of the invention will become apparent from the following detailed, non-limiting description.

### BRIEF DESCRIPTION OF THE DRAWINGS

The following detailed description makes reference to the accompanying drawings wherein:

FIG. 1 is a schematic view of an installation for providing steam according to the invention;

FIG. 2 is a schematic view of an installation for providing steam according to the invention, the installation being in a first configuration;

FIG. 3 is a schematic view of the installation shown in FIG. 2 in a second configuration;

FIG. 4 is a schematic view of the installation shown in FIG. 2 in a third configuration;

FIG. 5 is a schematic view of the installation shown in FIG. 2 in a fourth configuration;

FIG. 6 is a schematic view of the installation shown in FIG. 2 in a fifth configuration;

FIG. 7 is a schematic view of the installation shown in FIG. 2 in a sixth configuration;

FIG. 8 is a schematic view of the installation shown in FIG. 2 in a seventh configuration.

### DETAILED DESCRIPTION OF EMBODIMENTS

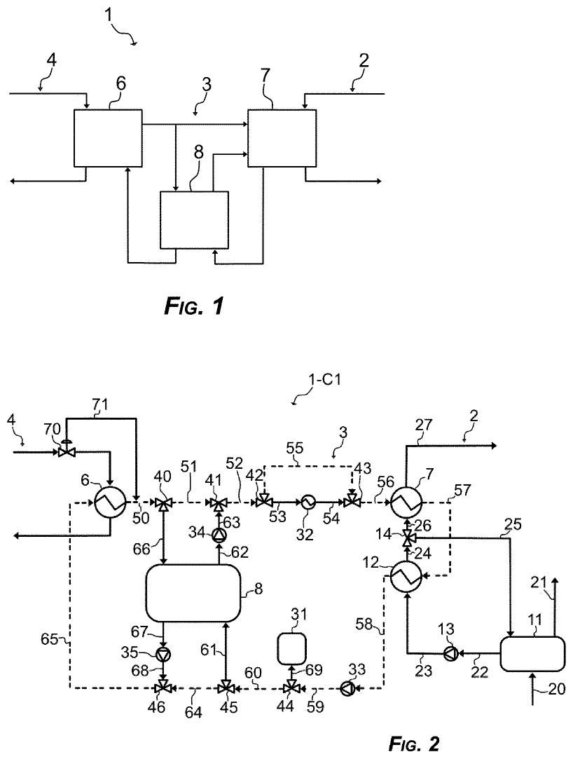

FIG. 1 shows a simplified schematic view of an installation 1 according to the invention.

The installation 1 comprises various fluid circuits 2, 3 and 4, each of which receives a first, second and third fluid.

In this non-limiting example, the first fluid, also known as the “output fluid”, comprises water, and the second fluid is a heat transfer fluid, such as oil or water.

The third fluid in this example comes from a waste heat source and can be gaseous and/or liquid. Non-limitingly, the third fluid, also known as the “input fluid”, may comprise a combustion gas, air or water vapor.

The installation 1 comprises heat transfer devices 6 and 7, as well as a thermal storage device 8.

In this example, the device 6 comprises a heat exchanger configured to transfer heat from the input fluid circulating in the circuit 4 to the heat transfer fluid circulating in the circuit 3.

By way of example, the device 6 can be a heat exchanger of the economizer-recovery type, for example a tube and fin exchanger, or a plate exchanger.

In this example, the device 7 comprises a superheater configured to transfer heat from the heat transfer fluid circulating in the circuit 3 to the output fluid circulating in the circuit 2, when the installation 1 is operating in a steam supply mode (see below).

The thermal storage device 8 is configured to store heat from the heat transfer fluid circulating in the circuit 3, when the installation 1 is operating in an energy storage mode (see below).

By way of example, the device 8 may take the form of a heat-insulated tank. In a non-limiting embodiment, such a tank comprises a heat storage medium, such as rock.

The installation 1 is configured so that it can be selectively placed in different configurations described further below with reference to FIGS. 2 to 8, including configurations in which the installation 1 operates in steam supply mode, configurations in which the installation 1 operates in energy storage mode, and configurations in which the installation 1 operates in both steam supply mode and energy storage mode.

Generally speaking, in energy storage mode, the fluids circulating in the installation 1 have respective temperatures such that, on the one hand, the exchanger 6 transfers heat from the input fluid circulating in the circuit 4 to the heat transfer fluid circulating in the circuit 3, thereby increasing the temperature of the heat transfer fluid and, on the other hand, the energy storage device 8 stores heat from the heat transfer fluid thus heated.

In steam supply mode, the fluids circulating in the installation 1 have respective temperatures such that the superheater 7 transfers heat from the heat transfer fluid circulating in the circuit 3 to the output fluid circulating in the circuit 2, arriving in the superheater 7 in the form of a flow in gaseous state, thus increasing the temperature of this gaseous flow. In steam supply mode, the heat transfer fluid entering the superheater 7 may come from the exchanger 6 and/or the energy storage device 8, depending on the configuration of the installation 1 (see below).

In this way, the installation 1 allows steam to be provided to said output fluid, in this case water vapor, in a substantially continuous manner, despite temporary variations in the temperature and/or flow rate of the input fluid.

By way of non-limiting example, the installation 1 can be used to supply steam to a method for producing hydrogen by high-temperature electrolysis. The invention can of course be implemented in many industrial steam generation applications and using an industrial installation such as a cement plant or similar as a source of waste heat.

FIGS. 2 to 8 show an installation 1 similar to that shown in FIG. 1, in different configurations.

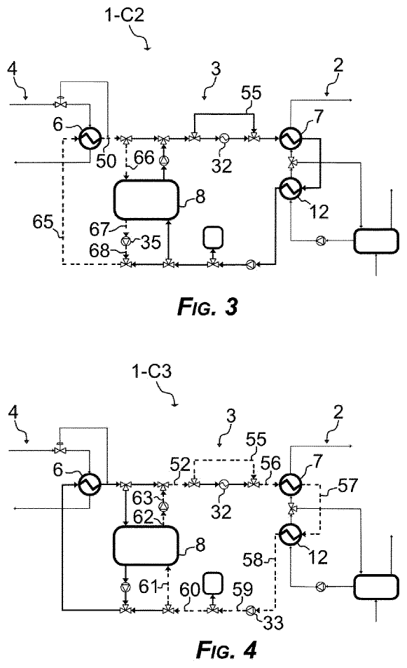

Compared with the simplified representation shown in FIG. 1, FIGS. 2 to 8 show some non-limiting structural details of the installation 1, described below with reference to FIG. 2. FIGS. 2 to 8 show the installation 1 with the same components in the same arrangement, but the reference signs for these components in FIG. 2 are not all repeated in FIGS. 3 to 8 to avoid overloading them.

With reference to the part of the installation 1 in FIG. 2 comprising the circuit 2 (toward the right of the figure), the installation 1 in this example comprises a deaerator 11, an evaporator 12, a pump 13, a valve 14 and pipes 20-27 forming the circuit 2 for conveying said first fluid, or output fluid, which in this case is water.

In this example, the water enters the deaerator 11, of the thermal steam deaerator type, in a liquid state via the pipe 20, for example from a water treatment unit (not shown). The deaerator 11 removes gases such as oxygen dissolved in the water, and discharges them through the pipe 21, which may be a vent.

The pump 13 extracts the treated water from the deaerator 11 and conveys it to the evaporator 12 via the pipes 22 and 23, typically at a pressure of between 1 bara (10⁵ Pa) and 15 bara (15×10⁵ Pa).

The evaporator 12 transforms the water into a gaseous state, in the form of saturated water vapor. Non-limitingly, the evaporator 12 may comprise a Kettle or plate-type exchanger.

On the one hand, the valve 14 allows all or part of this saturated steam to be routed to the deaerator 11, via the pipes 24 and 25, so as to preheat the water while keeping it in the deaerator 11 at a constant temperature.

On the other hand, the valve 14 allows all or part of the saturated steam leaving the evaporator 12 to be routed to the superheater 7, via the ducts 24 and 26, so as to form said gaseous flow.

The superheater 7, deaerator 11 and evaporator 12 form a steam generation module, with steam leaving the installation 1 via the pipe 27.

With reference to the part of the installation 1 in FIG. 2 including the circuit 3 (central part of the figure), the installation 1 in this example comprises an expansion vessel 31, a heating device 32, pumps 33-35, valves 40-46 and pipes 50-69 configured to receive the heat transfer fluid at a pressure that can typically be between 1 bara (10⁵ Pa) and 40 bara (40×10⁵ Pa).

The heating device 32 in this example comprises an electric heater which can be powered by an electrical energy storage device (not shown).

The exchanger 6 and the heater 32 are connected to one another by the pipes 50 to 53, via the valves 40 to 42.

The heater 32 and the superheater 7 are connected to one another by the pipes 54 and 56 via the valve 43.

The pipe 55 is connected to the valves 42 and 43 to form a bypass branch of the heater 32.

The superheater 7 and the evaporator 12 are connected to one another by the pipe 57.

The evaporator 12 and the pump 33 are connected to one another by the pipe 58.

The pump 33 and the exchanger 6 are connected to one another by the pipes 59, 60, 64 and 65 via the valves 44, 45 and 46.

The expansion vessel 31 is connected to the pipe 59 by the valve 44 via the pipe 69.

The energy storage device 8 is connected, on the one hand, to the exchanger 6 by the pipes 50 and 66 via the valve 40 and, on the other hand, to the pump 35 by the pipe 67, the pump 35 being connected to the pipe 65 by the pipe 68 via the valve 46.

The energy storage device 8 is also connected, on the one hand, to the pump 34 via the pipe 62, the pump 34 being connected to the valve 41 via the pipe 63 and, on the other hand, to the valve 45 via the pipe 61.

With reference to the part of the installation 1 in FIG. 2 comprising the circuit 4 (toward the left of the figure), the installation 1 in this example comprises a control valve 70 which is connected to the pipe 50 of the circuit 2 by a pipe 71 and is configured to adjust the flow rate of the fluid conveyed into the exchanger 6 by the circuit 4 so that the temperature of the heat transfer fluid circulating in the circuit 2 remains below a temperature threshold. This threshold can typically be 350 °C, or more preferentially 250 °C.

As a guide, the input fluid circulating in the circuit 4 can typically have a temperature of between 50 °C and 500 °C.

The different configurations of the installation 1 will now be described. Each of FIGS. 2 to 8 shows a respective configuration, in which the valves 40 to 46 of the circuit 3 are configured to circulate the heat transfer fluid in the circuit 3 in respective pipes of the circuit 3 indicated by dashed lines.

FIG. 2 shows the installation 1 in a configuration C1, also known as the “direct exchange configuration”.

In configuration C1, the valves 40-46 of the circuit 3 are configured to convey the heat transfer fluid from the exchanger 6 to the superheater 7 via the pipes 50, 51, 52, 55 and 56, then from the superheater 7 to the evaporator 12 via the pipe 57, then from the evaporator 12 to the exchanger 6 via the pipes 58, 59, 60, 64 and 65, under the action of the pump 33.

In this way, the heat transfer fluid passes directly from the exchanger 6 to the superheater 7, without passing through the thermal storage device 8 and bypassing the heater 32 via the branch 55. On leaving the evaporator 12, the heat transfer fluid is returned directly to the exchanger 6 by the pump 33, without passing through the thermal storage device 8.

The direct exchange configuration Cl thus implements said steam supply mode and does not implement said energy storage mode.

The installation 1 is typically placed in the direct exchange configuration C1 when the input fluid circulating in the circuit 4 has a slightly higher temperature than that of the gaseous flow leaving the superheater 7 via the pipe 27, for example with a difference of between 5 °C and 20 °C.

The above description of FIG. 2 applies by analogy to FIGS. 3 to 8, which are described below only in terms of their differences from the configuration C1 of FIG. 2.

FIG. 3 shows the installation 1 in a configuration C2, also known as the “thermal loading configuration”.

In configuration C2, the valves of the circuit 3 are configured to convey the heat transfer fluid from the exchanger 6 to the thermal storage device 8 via the pipes 50 and 66, and from the thermal storage device 8 to the exchanger 6 via the pipes 67, 68 and 65, under the action of the pump 35.

In this way, the heat transfer fluid passes directly from the exchanger 6 to the thermal storage device 8 without passing through the steam generation module or the part of the circuit 3 containing the heater 32.

Thus, the thermal loading configuration C2 implements said energy storage mode and does not implement said steam supply mode.

The installation 1 is typically placed in the thermal loading configuration C2 when the input fluid circulating in the circuit 4 has a temperature sufficient to allow heat storage and either when it is not desired to produce steam with the installation 1, or because the temperature of the input fluid is insufficient to heat the gaseous flow within the superheater 7.

FIG. 4 shows the installation 1 in a configuration C3, also known as the “thermal discharge configuration”.

In configuration C3, the valves of the circuit 3 are configured to convey the heat transfer fluid from the thermal storage device 8 to the superheater 7 via the pipes 62, 63, 52, 55 and 56, then from the superheater 7 to the evaporator 12 via the pipe 57, then from the evaporator 12 to the thermal storage device 8 via the pipes 58, 59, 60 and 61, under the action of the pump 33.

In this way, the heat transfer fluid passes directly from the thermal storage device 8 to the superheater 7, bypassing the heater 32 via the branch 55.

The thermal unloading configuration C3 thus implements said steam supply mode and does not implement said energy storage mode.

The installation 1 is typically placed in the thermal unloading configuration C3 when the temperature of the input fluid circulating in the circuit 4 is insufficient both to store heat in the thermal storage device 8 and to superheat the gaseous flow within the superheater 7, and when the amount of heat stored by the device 8 is sufficient to superheat the gaseous flow within the superheater 7.

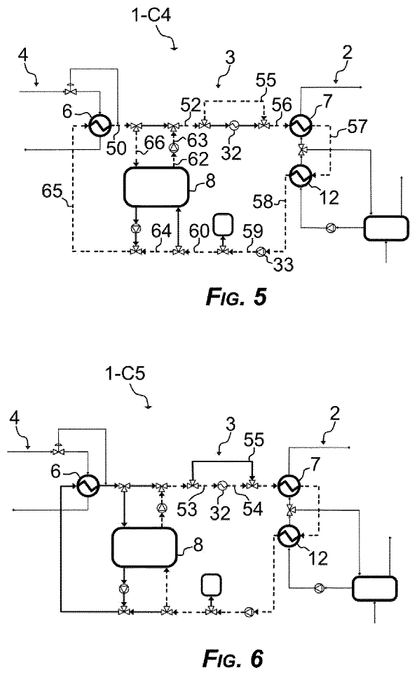

FIG. 5 shows the installation 1 in a configuration C4, also known as a “mixed configuration”.

In the mixed configuration C4, the valves of the circuit 3 are configured to convey the heat transfer fluid from the exchanger 6 to the thermal storage device 8 via the pipes 50 and 66, then from the thermal storage device 8 to the superheater 7 via the pipes 62, 63, 52, 55 and 56, then from the superheater 7 to the evaporator 12 via the pipe 57, then from the evaporator 12 to the exchanger 6 via the pipes 58, 59, 60, 64 and 65, under the action of the pump 33.

In this way, the heat transfer fluid passes from the exchanger 6 to the superheater 7 via the thermal storage device 8, bypassing the heater 32 via the branch 55. On leaving the evaporator 12, the heat transfer fluid is returned directly to the exchanger 6 by the pump 33, without passing through the thermal storage device 8.

The mixed configuration C4 thus implements both said steam supply mode and said energy storage mode.

The installation 1 is typically placed in the mixed configuration C4 when the input fluid circulating in the circuit 4 has a much higher temperature than that of the gaseous flow leaving the superheater 7, for example with a difference greater than or equal to 20 °C.

FIG. 6 shows the installation 1 in configuration C5, also known as the “electrical configuration”, which is described below only in terms of its differences from configuration C3.

Configuration C5 differs from configuration C3 in that the heat transfer fluid passes from the thermal storage device 8 to the superheater 7 via the electrical heater 32, that is, via the pipes 53 and 54 and not via the bypass pipe 55.

Configuration C5 therefore also implements said steam supply mode and does not implement said energy storage mode.

The installation 1 is typically placed in the electrical configuration C5 when the amount of heat stored by the device 8 is insufficient to superheat the gaseous flow within the superheater 7.

Configuration C5 can be implemented temporarily during start-up of the installation 1, before switching to the thermal unloading configuration C3 when thermodynamic conditions have stabilized or when sufficient temperatures have been reached.

The same applies to the direct exchange configuration C1 and the mixed configuration C4, which can be implemented after the installation 1 has been started up in configurations C6 and C7, respectively (see below).

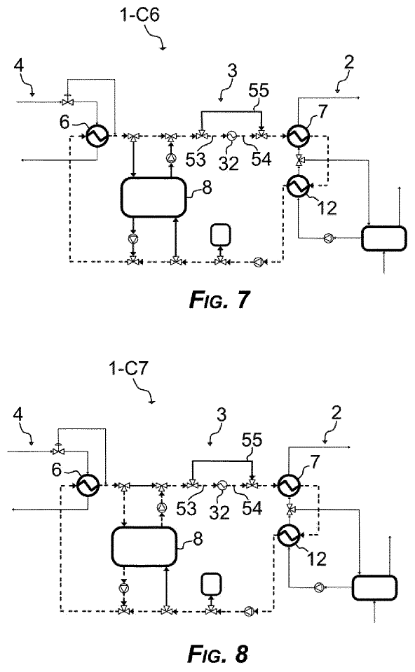

FIG. 7 shows the installation 1 in configuration C6, which is described below only in terms of its differences from configuration C1.

Configuration C6 differs from configuration C1 in that the heat transfer fluid passes from the exchanger 6 to the superheater 7 via the electrical heater 32, that is, via the pipes 53 and 54 and not via the bypass pipe 55.

FIG. 8 shows the installation 1 in a configuration C7, which is described below only in terms of its differences from configuration C4.

Configuration C7 differs from configuration C4 in that the heat transfer fluid passes from the thermal storage device 8 to the superheater 7 via the electrical heater 32, that is, via the pipes 53 and 54 and not via the bypass pipe 55.

Configurations C5, C6 and C7 can thus be implemented as electric start configurations.

The configuration of the installation 1 can be changed by control means (not shown), in particular to control the valves in the circuit 3.

The installation 1 may comprise one or more sensors (not shown), for example a temperature sensor for the input fluid circulating in the circuit 4, upstream of the exchanger 6.

The control means can be configured to place the installation 1 in one or another of the configurations described above based on one or more parameters, which may include the temperature of the input fluid measured using the aforementioned sensor.

For example, the control means can be configured to place the installation 1 in the direct exchange configuration C1 if the measured or estimated temperature of the input fluid is above a first predetermined temperature threshold and below a second predetermined temperature threshold.

Non-limitingly, the first threshold, respectively the second threshold, can correspond to a temperature of 5 °C, respectively 20 °C, above a measured or desired temperature of the gaseous flow leaving the superheater 7.

For another non-limiting example, the control means can be configured to place the installation 1 in the mixed configuration C4 if the measured or estimated temperature of the input fluid is above said second threshold.

Of course, many variations can be made to the foregoing description. For example, the steam generation module may comprise steam generation components other than the deaerator 11 and evaporator 12 described above and/or components otherwise arranged and/or produce steam from a fluid comprising different gas combinations. As an example of an alternative design, the steam generation module may be devoid of the recirculation pipe 25 between the evaporator 12 and the deaerator 11.

In the example shown in FIGS. 2 to 8, the installation 1 comprises an expansion vessel 31 which can be activated by opening the valve 44 (see FIG. 2). The expansion vessel 31 can be either of the diaphragm or bladder type. In alternative embodiments, such an expansion vessel 31 may be mounted on another part of the circuit 3 or be omitted from the circuit 3.

The installation 1 may comprise additional members and/or components not shown in FIG. 2. For example, the pump 33 can be mounted between the superheater 7 and the evaporator 12.

1. An installation for providing steam, comprising:
a first circuit configured to receive a first fluid;
a second circuit configured to receive a second heat transfer fluid;
a third circuit configured to receive a third fluid;
a first heat transfer device configured to transfer heat from said third fluid to said second fluid in order to increase the temperature of the second fluid;
a second heat transfer device configured to transfer heat from said second fluid to a flow of said first fluid in gaseous state in order to increase the temperature of the gaseous flow; and
a thermal storage device configured to store heat from said second fluid,
the installation being configured so that the installation can be selectively placed in one of several configurations from a list including:
a so-called “direct exchange configuration”, in which the second circuit is configured to convey the second fluid from the first heat transfer device to the second heat transfer device; and
a so-called “thermal discharge configuration”, wherein the second circuit is configured to convey the second fluid from the thermal storage device to the second thermal transfer device.

2. The installation according to claim 1, wherein said list includes a so-called “thermal loading configuration”, wherein the second circuit is configured to convey the second fluid from the first heat transfer device to the thermal storage device.

3. The installation according to claim 1, wherein said list includes a configuration, called the “mixed configuration”, wherein the second circuit is configured to convey the second fluid from the first heat transfer device to the thermal storage device and from the thermal storage device to the second heat transfer device.

4. The installation according to claim 1, comprising a heating device configured to raise the temperature of the second fluid upstream of the second heat transfer device.

5. The installation according to claim 4, wherein the second circuit comprises a heating device bypass branch, the second circuit being configured to convey the second fluid from the first heat transfer device to the second heat transfer device via the bypass branch when the installation is in said direct exchange configuration.

6. The installation according to claim 4, wherein said list includes a configuration, called the “electrical configuration”, wherein the second circuit is configured to convey the second fluid from the thermal storage device to the heating device and from the heating device to the second heat transfer device.

7. The installation according to claim 4, wherein said list includes a configuration wherein the second circuit is configured to convey the second fluid from the first heat transfer device to the heating device and from the heating device to the second heat transfer device.

8. The installation according to claim 4, wherein said list includes a configuration wherein the second circuit is configured to convey the second fluid from the first heat transfer device to the thermal storage device, from the thermal storage device to the heating device and from the heating device to the second heat transfer device.

9. The installation according to claim 1, comprising a sensor configured to estimate the temperature of said third fluid and control means configured to place the installation in said direct exchange configuration if the estimated temperature of the third fluid is above a first predetermined temperature threshold and below a second predetermined temperature threshold, the second threshold being lower than the first threshold.

10. A method for providing steam using an installation according to claim 1, comprising:
a heat transfer step, wherein said first heat transfer device is operated to transfer heat from the third fluid to the second fluid in order to increase the temperature of the second fluid; and
a control step, wherein the installation is selectively placed in one of several configurations from a list including:
a so-called “direct exchange configuration”, wherein said second circuit is configured to convey the second fluid from the first heat transfer device to the second heat transfer device so as to perform a superheating step, wherein the second heat transfer device is operated to transfer heat from the second fluid to a flow of the first fluid in gaseous state in order to increase the temperature of this gaseous flow; and
a so-called “thermal discharge configuration”, wherein the second circuit is configured to convey the second fluid from the thermal storage device to the second heat transfer device, wherein the second heat transfer device is operated to transfer heat from the second fluid to a flow of the first fluid in gaseous state in order to increase the temperature of this gaseous flow.
